(19) United States
(12) Patent Application Publication
(10) Pub. No.: US 2019/0156712 A1
(43) Pub. Date: May 23, 2019

(54) ANTI-BUMP APPARATUS FOR BELT LOADER

(71) Applicant: William J. Boyer, JR., Black Diamond, WA (US)

(72) Inventor: William J. Boyer, JR., Black Diamond, WA (US)

(21) Appl. No.: 16/194,178

(22) Filed: Nov. 16, 2018

Related U.S. Application Data
(60) Provisional application No. 62/588,272, filed on Nov. 17, 2017.

(51) Int. Cl. G09F 17/00; B65G 67/08

(52) U.S. Cl. CPC G09F 17/00; B65G 67/08; G09F 2017/0075; G09F 2017/0066; B65G 2201/0264; B65G 2814/0398; G09F 2017/0083

(57) ABSTRACT

The present technology relates generally to an anti-bump apparatus attached to an end portion of a belt loader and configured to create a space between the end portion and a baggage cart. The anti-bump apparatus includes a shaft portion and a flag portion attached to the shaft portion. The shaft portion is coupled to the end portion of the belt loader with a mounting portion formed from a pivot plate and a mounting plate. The pivot plate is pivotable relative to the mounting plate allowing the anti-bump apparatus to be in either a stowed position or a deployed position. A locking mechanism formed from a locking pin in the pivot plate and a plurality of locking pin holes in the mounting plate ensure that the anti-bump apparatus does not prematurely transition from one position to the other.

### CROSS-REFERENCE TO RELATED APPLICATION

This non-provisional patent application claims the benefit of and priority to U.S. Provisional Patent Application No. 62/588,272, titled “ANTI-BUMP APPARATUS FOR BELT LOADER” and filed Nov. 17, 2017, which is incorporated herein in its entirety by reference thereto.

### TECHNICAL FIELD

This application relates to an anti-bump flag attachment for a baggage belt loader.

### BACKGROUND

When traveling by commercial airplane, passengers often bring at least one piece of baggage onto the plane. If the piece of baggage is unable to be accommodated in the main cabin of the airplane, the piece of baggage is checked so that it may be stored in a baggage storage area within the airplane. The checked bag is tagged and transported out of the airport terminal and placed on a baggage cart to be transported to the airplane for storage. A towing tractor brings the baggage cart to the airplane and a baggage handler transfers the pieces of baggage from the baggage cart to a belt loader. The belt loader includes a conveyor belt used to transport the pieces of baggage up to the baggage storage area in the airplane.

Baggage handlers responsible for transferring the pieces of baggage from the baggage cart to the belt loader are often required to carry and move hundreds of pieces of baggage for any one flight, with pieces of baggage often weighing more than 50 pounds. If the operator of the towing tractor gets too close and accidently hits the belt loader with the tractor or any of the tugs being towed, the belt loader and the aircraft can be severely damaged, which may require a temporary delay or grounding of the aircraft. Also, if the operator of the towing tractor positions the baggage cart too far away from the belt loader, the baggage handlers may be forced to carry each of the pieces of baggage an extended distance, placing unnecessary and undesirable amounts of stress on the baggage handlers. On the other hand, if the operator of the towing tractor positions the baggage cart too close to the belt loader, there may not be enough room between the baggage cart and the belt loader for the baggage handler to quickly and efficiently transfer the pieces of baggage. It would therefore be desirable to implement a means for ensuring that the baggage cart is always placed a suitable distance away from the belt loader.

### BRIEF DESCRIPTION OF THE DRAWINGS

FIG. 1 is an isometric view of the anti-bump apparatus in a stowed position in accordance with the present technology.

FIG. 2 is an isometric view of the anti-bump apparatus in a deployed position in accordance with the present technology.

FIG. 3 is an isometric view of the anti-bump apparatus in the deployed position in accordance with the present technology.

FIG. 4 is an enlarged front elevation view of an attachment assembly of the anti-bump apparatus configured in accordance with the present technology.

FIG. 5 is a front elevation view of another embodiment of the anti-bump apparatus, configured in accordance with the present technology

### DETAILED DESCRIPTION

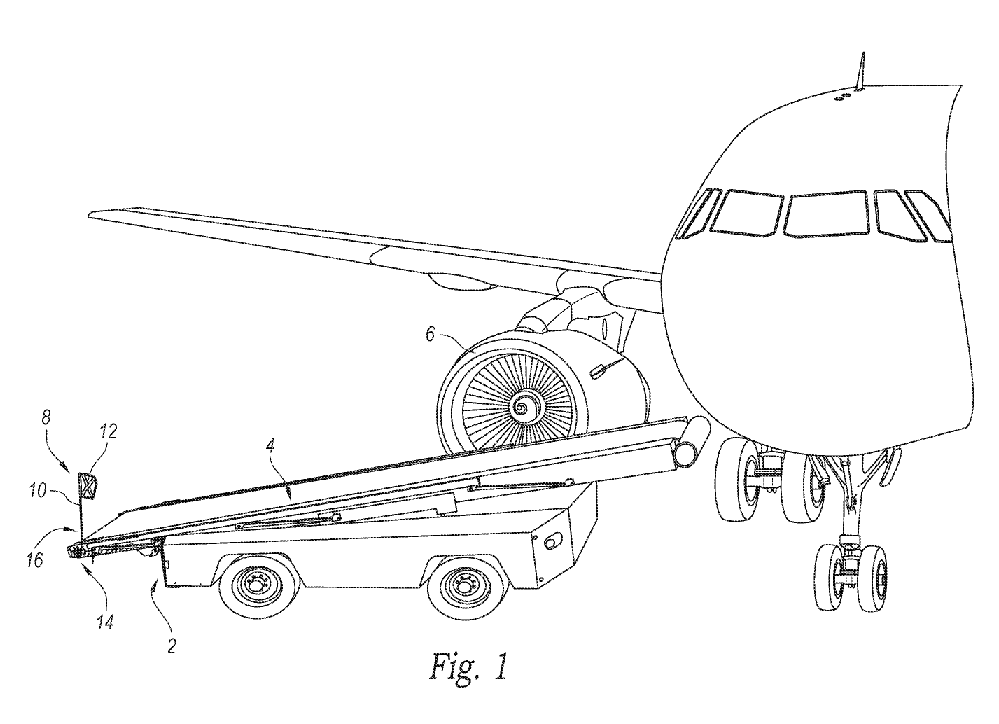

The present technology is directed to an anti-bump apparatus for a baggage belt loader and associated systems. Several embodiments of the present technology are related to a mounting assembly attachable to an end portion of a belt loader and having a rotatable indicator portion attachable to the mounting assembly that extends away from the end portion of the belt loader. Operators of the baggage cart can use the indicator portion as a guide when positioning the baggage cart near the belt loader so that the baggage cart is not too close to, or too far away from, the end portion of the belt loader. Specific details of the present technology are described herein with reference to FIGS. 1-5. Although many of the embodiments are described with respect to baggage loading apparatuses and systems, it should be noted that other applications and embodiments in addition to those disclosed herein are within the scope of the present technology. Further, embodiments of the present technology can have different configurations, components, and/or procedures than those shown or described herein. Moreover, a person of ordinary skill in the art will understand that embodiments of the present technology can have configurations, components, and/or procedures in addition to those shown or described herein and that these and other embodiments can be without several of the configurations, components, and/or procedures shown or described herein without deviating from the present technology.

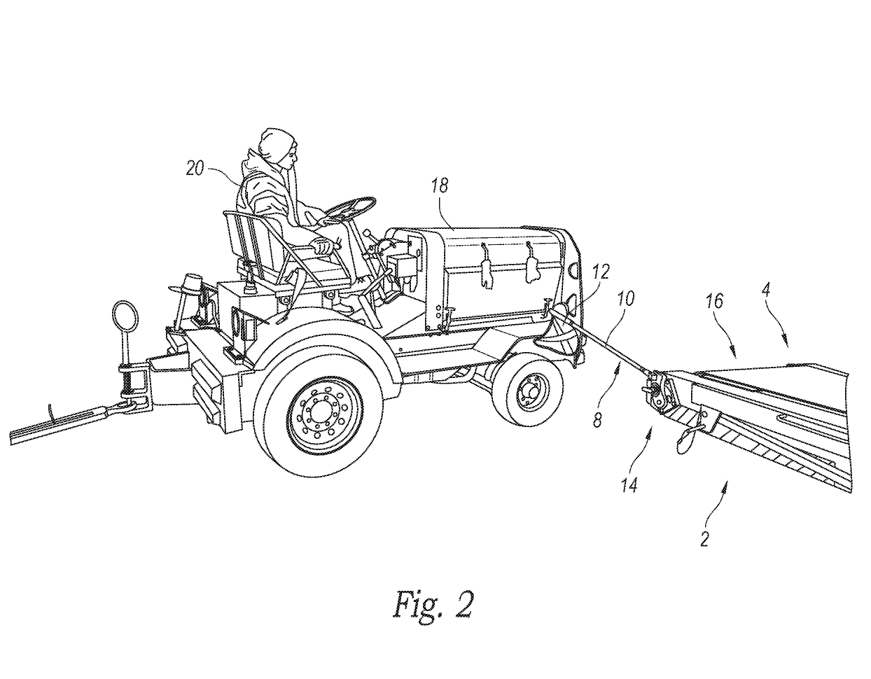

FIG. 1 is an isometric view of an anti-bump apparatus 8. The anti-bump apparatus 8 is attached to an end portion 16 of a belt loader 2 having a conveyor belt 4 configured to transport baggage from the end portion 16 to a cargo area of an airplane 6. The anti-bump apparatus 8 includes a shaft portion 10 having a length L, an indicator 12 (e.g., a flag) coupled to the end of the shaft portion 10, and an attachment assembly 14 used to attach the anti-bump apparatus 8 to the proximal end portion 16 of the belt loader 2. The anti-bump apparatus 8 may be operable in a stowed position and a deployed position. In the stowed position, the anti-bump apparatus 8 has a first orientation relative to the belt loader 2, such as a generally vertical orientation with the shaft portion 10 being generally perpendicular to the ground (FIG. 1) or a generally horizontal position with the shaft portion being immediately alongside the frame of the belt loader. In this stowed position, the anti-bump apparatus 8 is stowed out of the way of any traffic passing by the proximal end 16 of the belt loader 2. In the illustrated embodiment, the indicator 12 is held at an upright position when the apparatus is in the stowed position so as to increase the visibility of the anti-bump apparatus 8, making it easier for the operator 20 of the towing tractor 18 (FIG. 2) to see or otherwise locate the belt loader 2. In other embodiments, the indicator can be in other positions relative to the belt loader 2 while being positioned generally away from the proximal end of the belt loader.

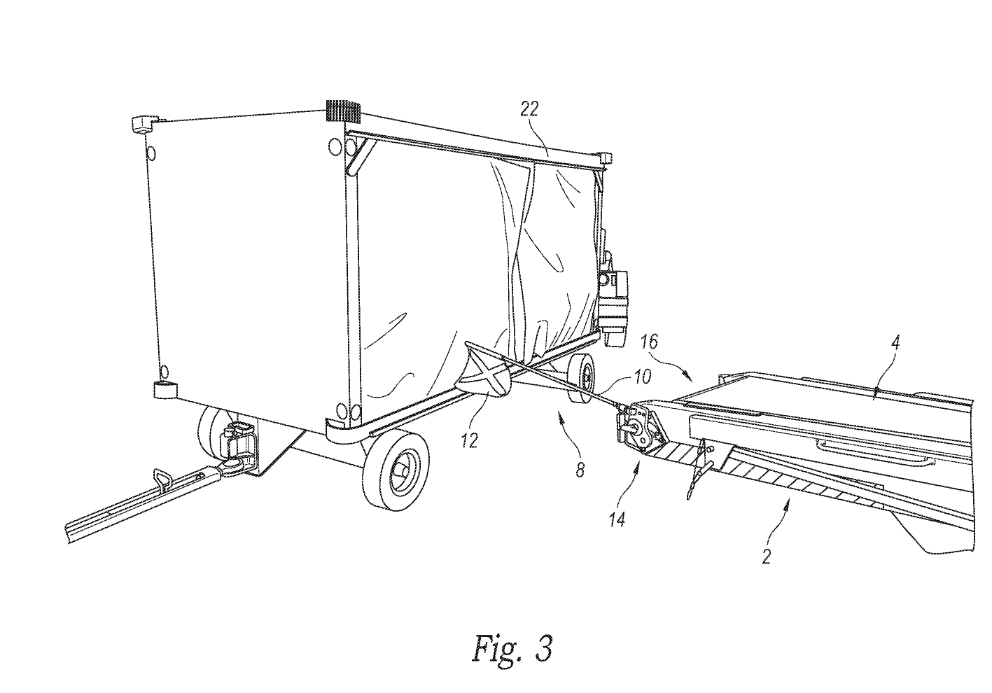

FIGS. 2 and 3 are isometric views of the anti-bump apparatus 8 in the deployed position. Before a towing tractor 18 approaches the belt loader 2, such as to load or unload back to or from the airplane, a baggage handler or other user may transition the anti-bump apparatus 8 from the stowed position to the deployed position by pivoting the shaft portion 10 and indicator 12 about the attachment assembly 14. When in the deployed position, the anti-bump apparatus 8 has a horizontal orientation with the shaft portion 10 being generally parallel to the ground and projecting axially from the proximal end portion 16 of the belt loader 2. The shaft portion 10 and indicator 12 provide a visual indicator to ground personnel, such as the operator 20 of the towing tractor 18, regarding the location of the proximal end of the belt loader 2. Further, the shaft portion 10 and indicator 12 can indicate a defined distance away from the proximal end 16 of the belt loader 2 so that the operator 20 can accurately determine where the towing tractor 18 should be positioned relative to the proximal end 16. Accordingly, the operator uses the anti-bump apparatus 8 as a visual indicator to help avoid running the tractor 18 into the belt loader 2 as the tractor 18 approaches the belt loader 2. The operator 20 may also use the horizontal anti-bump apparatus 8 to align and position the towing tractor 18 a given distance away from the end portion 16 of the belt loader 2, where the given distance is substantially equal to the length of the shaft portion 10. After aligning and positioning the towing tractor 18, the operator 20 may continue to drive the towing tractor forward until the baggage cart 22 (FIG. 3) is aligned with the proximal end portion 16 of the belt loader 2 and separated from the end portion 16 of the belt loader 2 by a distance substantially equal to the length of the shaft portion 10.

The length of the shaft portion 10 is such that the distance between the end portion 16 of the belt loader 2 and a properly-positioned baggage cart 22 is small enough that the baggage handlers can avoid carrying the baggage pieces an unnecessarily far distance while remaining large enough that the baggage handlers are freely maneuverable between the baggage cart 22 and the belt loader 2. In this way, the baggage handlers avoid exerting excessive amounts of energy transferring baggage between the baggage cart 22 and the belt loader 2 while retaining their freedom of movement. In some embodiments, the length of the shaft portion 10 can be approximately 1 meter. In other embodiments, the length of the shaft portion 10 can be some other suitable length.

After the baggage handlers finish transferring all of the baggage pieces between the belt loader 2 and the baggage cart 22, the operator 20 may use the towing tractor 18 to move the baggage cart 22 away and the baggage handlers may rotate the anti-bump apparatus 8 back into the stowed position so that the anti-bump apparatus 8 is out of the way of any passing workers and/or traffic. However, this is merely an example. In other embodiments, the anti-bump apparatus may be operable in a third position in which the shaft portion 10 is rotated by 180° relative to the position of the shaft portion 10 when the anti-bump apparatus 8 is in the deployed position. In this way, the shaft portion 10 is aligned with the conveyor belt 4 and is stored out of the way of any passing traffic. In still other embodiments, the shaft portion 10 may be detachable from the attachment assembly 14. In these embodiments, the shaft portion 10 and the indicator 12 may be removed from the attachment assembly 14 and separately stored after the baggage pieces have been transferred.

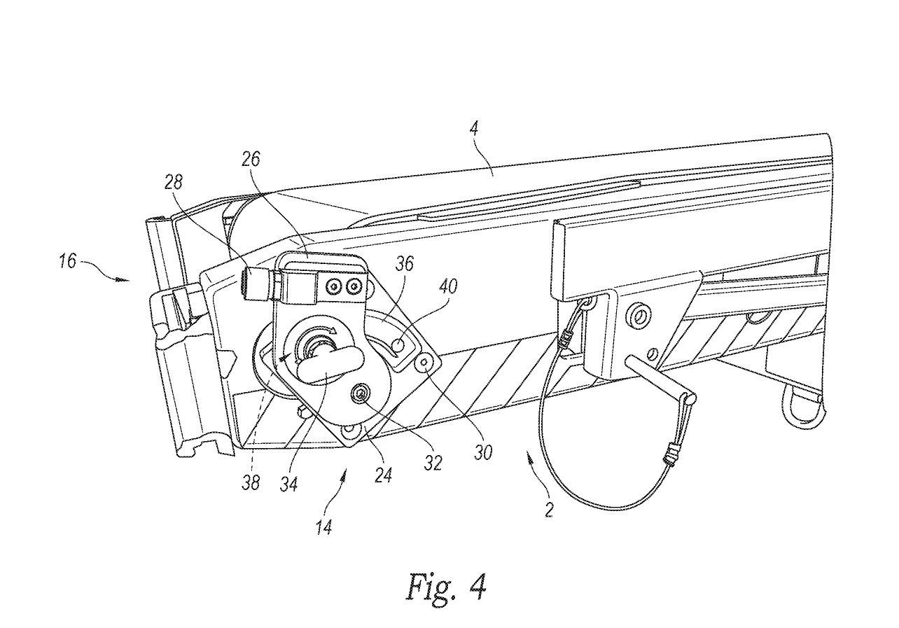

FIG. 4 is an enlarged elevation view of the attachment assembly 14 coupled to the proximal end portion 16 of the belt loader 2. The attachment assembly 14 includes a mounting plate 24 attached to the frame of the belt loader 2 with bolts 30, and a pivot plate 26 rotatably coupled to the mounting plate 24 with a pivot screw 32 or other pivot connection system. The pivot plate 26 includes a removable/replaceable shaft attachment assembly 28 configured to removably receive the shaft portion 10 of the anti-bump apparatus 8 while the mounting plate 24 includes a groove 36 formed in the mounting plate 24. The attachment assembly 14 also includes a locking pull pin 34 that passes through the pivot plate 26 and is configured to be received within each of the first and second locking pin holes 38, 40 formed in the groove 36.

When the anti-bump apparatus 8 is in the deployed position, the pivot plate 26 is rotated relative to the mounting plate 24 such that the locking pull pin 34 is positioned over and engaged with the first locking pin hole 38. A spring coupled to the pivot plate 26 and the locking pull pin 34 applies a biasing axial force on the locking pin 34 so that the locking pin 34 remains securely engaged with the first locking pin hole 38, thereby ensuring that the shaft portion 10 and indicator 12 remain locked in the generally horizontal orientation. The locking pin 34 may include a handle (or other grabbing means) that allow a user to securely grasp the locking pin 34. Pulling on the handle of the locking pin 34 compresses the spring and causes the locking pin 34 to retract out of the first locking pin hole 38, disengaging the locking pin 34 from the pin hole 40. Disengaging the locking pin 34 from the locking pin hole 40 allows the pivot plate 26 to freely rotate about the pivot screw 32.

After the pulling on the handle of the locking pin 34, an operator of the anti-bump apparatus 8 may rotate the pivot plate 26, shaft portion 10, and indicator 12 about the pivot screw 32. As the anti-bump apparatus 8 rotates, the locking pin 34 rotates through the groove such that the locking pin 34 remains adjacent to the bottom surface of the groove 36. The pivot plate 26, shaft portion 10, and indicator 12 may rotate about the pivot screw 32 until the shaft portion 10 has a generally vertical orientation. At this point, the locking pin 34 may be arranged over the second locking pin hole 40 and the force applied by the compressed spring on the locking pin 34 may force the locking pin 34 into the second locking pin hole 40, engaging the locking mechanism to keep the anti-bump apparatus 8 in the stowed position.

The anti-bump apparatus 8 may remain in the stowed position until the operator desires to transition the anti-bump apparatus from 8 from the stowed position to the deployed position. Pulling the handle of the locking pin 34 disengages the locking pin from the second locking pin hole 40. Once disengaged, the pivot plate 26, shaft portion 10, and indicator 12 may rotate about the pivot screw 32 relative to the mounting plate 24 until the shaft portion 10 has a generally vertical orientation. At this point, the locking pin 34 may be arranged over the first locking pin hole 38 and the spring may force the locking pin into the first locking pin hole 38, engaging the locking mechanism to keep the anti-bump apparatus 8 in the stowed position.

The conveyor belt 4 of the belt loader 2 may be operable at a range of angles relative to the ground. To ensure that the shaft portion 10 of the anti-bump apparatus 8 has a generally horizontal orientation when the anti-bump apparatus 8 is in the deployed position and a generally vertical orientation when the anti-bump apparatus 8 is in the stowed position, the mounting plate 24 may include additional locking pin holes 38 in the groove 36. The pivot plate 26 may be rotatable about the pivot screw 32 such that the locking pin 34 is engageable with any of the additional locking pin holes. In this way, the shaft portion 10 may be arranged in the generally horizontal or generally vertical orientations regardless of the orientation of the conveyor belt 4 of the belt loader 2.

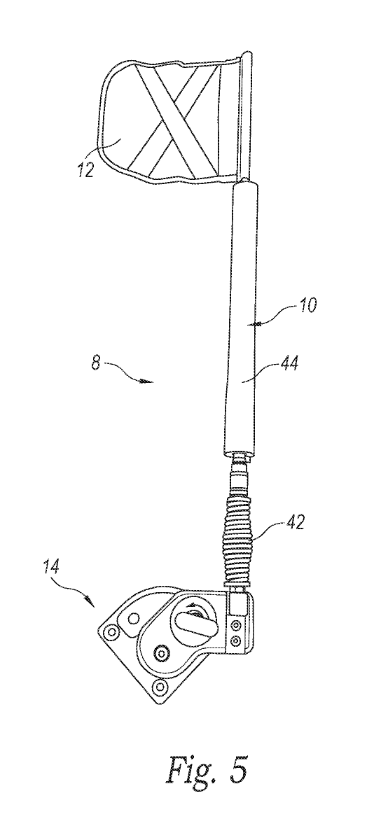

FIG. 5 shows another embodiment to the anti-bump apparatus 8. In the illustrated embodiment, the anti-bump apparatus 8 includes spring 42 and padding 44 coupled to the shaft portion 10. The spring 42 is coupled between the shaft portion 10 and the attachment assembly 14 and is configured to increase the flexibility and bendability of the anti-bump apparatus 8 such that, when the shaft portion 10 is struck by an object when the apparatus 8 is in the deployed position, the shaft portion is able to bend out of the way to reduce the likelihood of the apparatus 8 breaking. Additionally, the padding 44 can be used to protect the shaft portion 10 from, as an example, an impact from a foreign object, such as the towing tractor 18 or personnel moving around the belt loader 2.

In the illustrated embodiments, the anti-bump apparatus 8 is attached to the proximal end portion 16 of the belt loader 2 and the shaft portion 10 is positioned such that, when the anti-bump apparatus 8 is in the deployed configuration, the anti-bump apparatus 8 extends rearwardly from the proximal end portion 16. In other embodiments, however, the anti-bump apparatus 8 can be attached to a different portion of the belt loader 2 and/or can be configured to extend in a different direction relative to the belt loader 2. For example, in some embodiments, the anti-bump apparatus 8 can be configured to extend laterally from a side of the belt loader 2. In general, the anti-bump apparatus 8 can be positioned and configured such that the anti-bump apparatus 8 extends in any suitable direction from any suitable portion of the belt loader 2.

From the foregoing, it will be appreciated that specific embodiments of the invention have been described herein for purposes of illustration, but that various modifications may be made without deviating from the scope of the invention. Accordingly, the invention is not limited except as by the appended claims.

I claim:

1. An anti-bump apparatus for use with a belt loader having a conveyor assembly, the apparatus comprising:
an attachment assembly having a mounting plate securely attached to an end portion of the conveyor assembly and a pivot plate rotatably coupled to the mounting plate; and
a shaft portion coupled to the pivot plate and operable in a stowed orientation and a deployed orientation, wherein the shaft portion is movable between the stowed and deployed orientations by rotating the pivot plate relative to the mounting plate.

2. The anti-bump apparatus of claim 1, wherein the attachment assembly comprises a shaft attachment assembly coupled to the pivot plate and configured to receive the shaft portion.

3. The anti-bump apparatus of claim 1, wherein the attachment assembly further comprises:
a pivot screw, wherein the pivot plate is coupled to the mounting plate with the pivot screw and wherein the pivot plate is configured to rotate relative to the mounting plate by rotating about the pivot screw.

4. The anti-bump apparatus of claim 1 wherein the attachment assembly further comprises:
a groove formed in the mounting plate;
a plurality of locking pin holes formed in the groove; and
a pull pin that extends through the pivot plate and that is engageable with individual of the plurality of locking pin holes.

5. The anti-bump apparatus of claim 4 wherein the plurality of locking pin holes comprises a first locking pin hole and a second locking pin hole and wherein the shaft portion is in the deployed orientation when the pull pin is engaged with the first locking pin hole and in the stowed orientation when the pull pin is engaged with the second locking pin hole.

6. The anti-bump apparatus of claim 5 wherein the shaft portion is configured to move from the deployed position to the stowed position by disengaging the pull pin from the first locking pin hole, rotating the pivot plate until the pull pin is positioned over the second locking pin hole, and engaging the pull pin with the second locking pin hole.

7. The anti-bump apparatus of claim 5, wherein the attachment assembly further comprises:
a spring coupled to the pull pin, wherein the spring is configured to apply a force on the pull pin to engage the pull pin with individual of the plurality of locking pin holes.

8. The anti-bump apparatus of claim 1, further comprising:
padding disposed around the shaft portion; and
a spring coupled between the shaft portion and the attachment assembly.

9. The anti-bump apparatus of claim 1, further comprising:
a flag coupled to the shaft portion.

10. The anti-bump apparatus of claim 1 wherein the shaft portion has a generally lateral orientation when the shaft portion is in the deployed orientation and a generally vertical orientation when the shaft portion is in the stowed orientation.

11. A belt loader for loading baggage onto and off of an airplane, comprising:
a conveyor assembly; and
an anti-bump apparatus attached to an end portion of the conveyor belt, wherein the anti-bump apparatus comprises:
an attachment assembly having a mounting plate securely attached to an end portion of the conveyor assembly and a pivot plate rotatably coupled to the mounting plate; and
a shaft portion coupled to the pivot plate, wherein the anti-bump apparatus is operable in a deployed configuration and a stowed configuration and wherein the anti-bump apparatus is configured to move between the deployed configuration and the stowed configuration by rotating the pivot plate and shaft portion relative to the mounting plate.

12. The belt loader of claim 11, wherein the attachment assembly further comprises:
a pivot pin coupled between the pivot plate and the mounting plate wherein the pivot plate is configured to rotate relative to the mounting plate by rotating about the pivot pin.

13. The belt loader of claim 11, wherein the attachment assembly further comprises:
a groove formed in the mounting plate
first and second locking pin holes formed in the groove;
a pull pin that extends through the pivot plate and that is engageable with the first and second locking pin holes; and
a spring coupled to the pull pin and configured to push the pull pin so that the pull pin engages with the first and second locking pin holes.

14. The belt loader of claim 13 wherein the anti-bump apparatus is in the deployed configuration when the pull pin is engaged with the first locking pin hole and the stowed configuration when the pull pin is engaged with the second locking pin hole.

15. The belt loader of claim 14 wherein the anti-bump apparatus is configured to move from the deployed configuration to the stowed configuration by disengaging the pull pin from the first locking pin hole, rotating the shaft portion and pivot plate relative to the mounting plate until the pull pin is positioned over the second locking pin hole, and engaging the pull pin with the second locking pin hole.

16. The belt loader of claim 14, wherein—
the belt loader is operable at first and second angles with respect to the ground,
the deployed configuration comprises a first deployed configuration,
the anti-bump apparatus is operable in a second deployed configuration different from the first deployed configuration,
the attachment assembly comprises a third locking pin hole formed in the groove,
the anti-bump apparatus is in the second deployed configuration when the pull pin is engaged with the third locking pin hole,
when the anti-bump apparatus is in the first deployed configuration and the belt loader is operating at the first angle, the shaft portion is generally horizontal, and
when the anti-bump apparatus is in the second deployed configuration and the belt loader is operating at the second angle, the shaft portion is generally horizontal.

17. The belt loader of claim 11 wherein the shaft portion has a length of approximately 1 meter.

18. A method of manufacturing an anti-bump apparatus for use with a belt loader having a conveyor assembly, the method comprising:
providing an indicator having a shaft portion;
providing a mounting plate configured to be securely attached to the conveyor assembly;
providing a pivot plate having a shaft attachment portion configured to securely receive the shaft portion;
providing a pivot pin;
coupling the pivot plate to the mounting plate using the pivot pin such that pivot plate can rotate relative to the mounting plate by rotating about the pivot pin; and
coupling the indicator to the pivot plate by coupling the shaft portion to the shaft attachment portion.

19. The method of claim 18 wherein—
the mounting plate comprises a groove that includes first and second locking pin holes,
the pivot plate comprises a pull pin that extends through the pivot plate, and
the pull pin is engageable with the first and second locking pin holes.

20. The method of claim 19 wherein the anti-bump apparatus is operable in a stowed position and a deployed position and wherein the anti-bump apparatus is in the deployed position when the pull pin is engaged with the first locking pin hole and the stowed position when the pull pin is engaged with the second locking pin hole.
